(19) United States
(12) Patent Application Publication
(10) Pub. No.: US 2011/0215927 A1
(43) Pub. Date: Sep. 8, 2011

(54) ELECTRONIC DEVICE WITH ANTI-THEFT PROTECTION AND MERCURY CONNECTOR THEREOF

(75) Inventors: HUNG CHAO, Tu-Cheng (TW); JUI-HSIUNG HO, Tu-Cheng (TW); WANG-DING SU, Tu-Cheng (TW); SHEN-CHUN LI, Tu-Cheng (TW); HSIEN-CHUAN LIANG, Tu-Cheng (TW)

(73) Assignee: HON HAI PRECISION INDUSTRY CO., LTD., Tu-Cheng (TW)

(21) Appl. No.: 12/766,993

(22) Filed: Apr. 26, 2010

(30) Foreign Application Priority Data
Mar. 4, 2010 (TW) 99106237

(51) Int. Cl. G08B 13/14

(52) U.S. Cl. 340/568.2

(57) ABSTRACT

An electronic device with anti-theft protection includes an alarm unit, a mercury connector, and a microprocessor connected therebetween. The mercury connector includes a body containing mercury, and first and second leads arranged on the body. The microprocessor includes a first signal terminal and a second signal terminal. The first signal terminal is connected to the first lead. The second signal terminal is connected to the second lead. When the microprocessor has entered the anti-theft mode, if the electronic device is moved, the first lead connects to the second lead via the mercury and forms a circuit path from the first signal terminal to the second signal terminal. The microprocessor starts the alarm unit to generate an alarm.

### BACKGROUND

1. Technical Field

The present disclosure relates to electronic devices and, particularly, to an electronic device with anti-theft protection and a mercury connector used therein.

2. Description of Related Art

Despite benefits of portability and general convenience, portable computers present a downside, due to their ease of transport and concealment, they are frequently stolen.

### BRIEF DESCRIPTION OF THE DRAWINGS

FIG. 1 is a block diagram of an embodiment of an electronic device with anti-theft protection; the electronic device including a mercury connector.

FIG. 2 is a schematic view of an embodiment of the mercury connector of FIG. 1.

FIG. 3 is a schematic view of another embodiment of the mercury connector of FIG. 1.

FIG. 4 is a cutaway, isometric view of FIG. 3.

### DETAILED DESCRIPTION

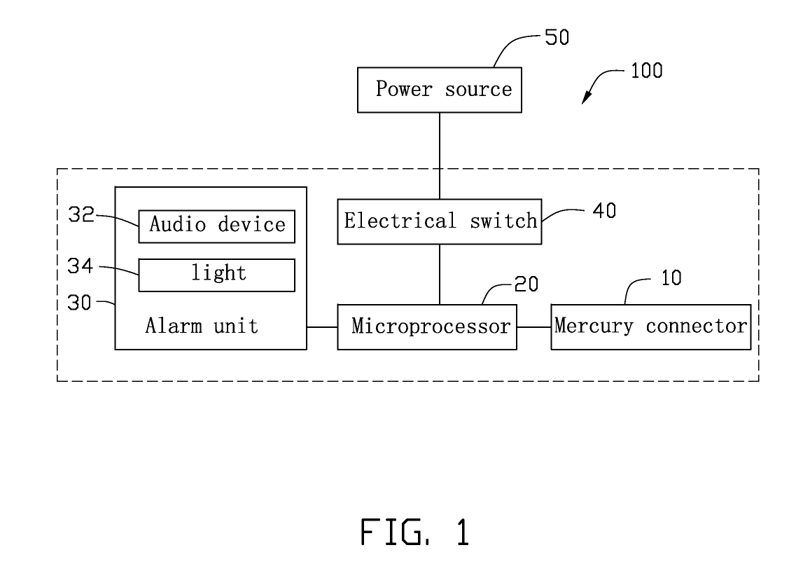

Referring to FIG. 1, an exemplary embodiment of an electronic device with anti-theft protection includes a mercury connector 10, a microprocessor 20, an alarm unit 30, and an electrical switch 40. The electrical switch 40 is mounted on the electrical device, and connected between a power source 50 and the microprocessor 20. The microprocessor 20 is connected between the alarm unit 30 and the mercury connector 10. In the embodiment, the electronic device is a notebook computer 100. The microprocessor 20 can enter an anti-theft mode by action of the electrical switch 40 or by operation of an application controller installed on the notebook computer 100.

If the application is used to activate the microprocessor 20 to enter the anti-theft mode, a standby state or locked state is detected. The anti-theft mode is disabled when the notebook computer 100 exits the standby or locked state.

If the electrical switch 40 is used to activate the microprocessor 20 to enter the anti-theft mode, the electrical switch 40 is turned on. When the electrical switch 40 is turned off, the microprocessor 20 exits anti-theft mode. If the user only selects the mode of the application to activate the microprocessor 20 to enter the anti-theft mode, the electrical switch 40 can be omitted.

The alarm unit 30 includes a light 32 and an audio device 34. In other embodiments, only one of these may be used, or other elements providing alarm functionality can be used.

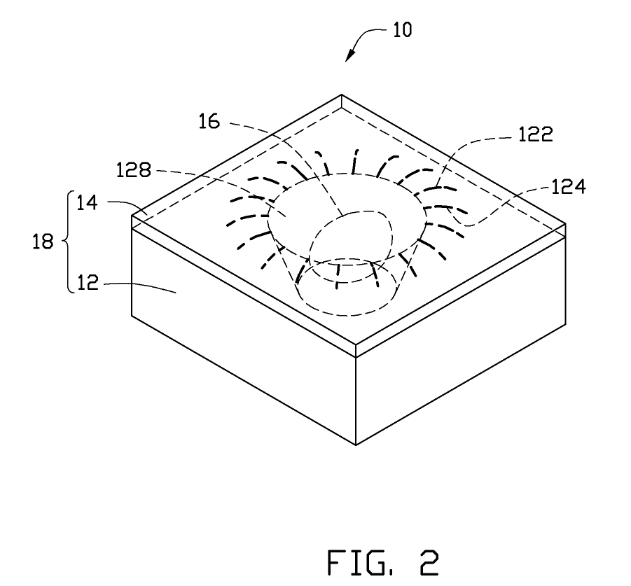

Referring to FIG. 2, the mercury connector 10 includes a cube-shaped body 18. The body 18 includes a base 12 and a cover 14 hermetically covering the base 12. A tapered well 128 is defined in a center of the base 12, containing mercury 16. A plurality of power leads 122 and a plurality of ground leads 124 are arranged alternately and radially from an edge of a top of the well 128. First terminals of the plurality of power leads 122 are connected to a power signal terminal (not shown) of the microprocessor 20. Second terminals opposite to the first terminals of the plurality of power leads 122 are at the edge of the top of the well 126. First terminals of the plurality of ground leads 124 are connected to ground signal terminals (not shown) of the microprocessor 20. Second terminals opposite to the first terminals of the plurality of ground leads 124 are at the edge of the top of the well 126.

When the application activates the microprocessor 20 to enter the anti-theft mode, the notebook computer 100 is in a standby or locked state. If the electrical switch 40 is used, the switch is turned on. In operation, the notebook computer 100 is in a horizontal orientation, the mercury 16 is in the bottom of the well 128. The second terminals of the plurality of power leads 122 are disconnected from the second terminals of the plurality of ground leads 124. Movement of the notebook computer 100 causes the mercury 16 to move from the bottom to the top of the well 128, whereupon the mercury 16 electrically connects the second terminals of the plurality of power leads 122 to the plurality of ground leads 124. This connection completes a circuit path from the power signal terminal to the ground signal terminal of the microprocessor 20, which, in turn, starts the elements of the alarm unit 30. Where, a volume of the mercury 16 is not large enough to connect two second terminals of power leads 122 or ground leads 124. Thereby not causing a short circuit.

To exit the anti-theft mode, the standby or locked state must be exited. Alternatively, turning the electrical switch 40 off similarly causes the anti-theft mode to be exited.

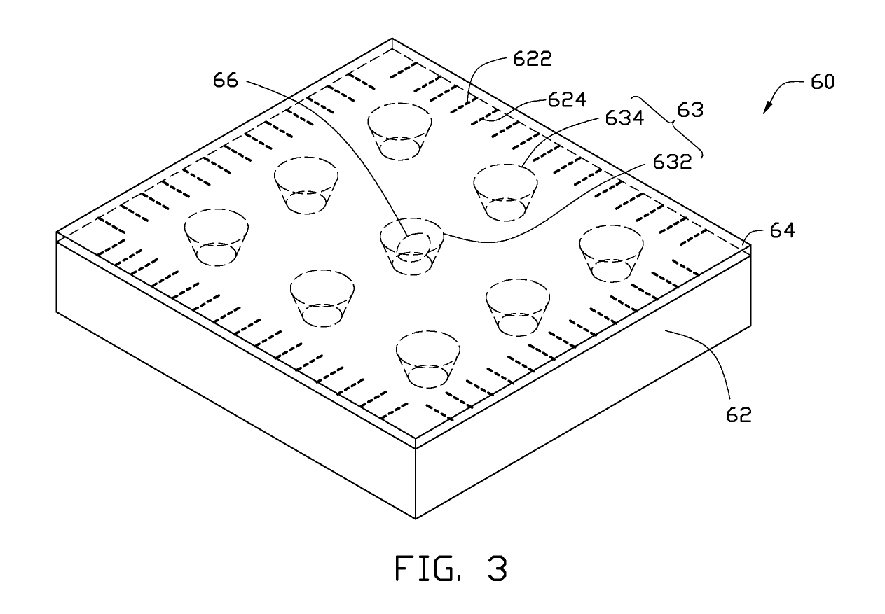

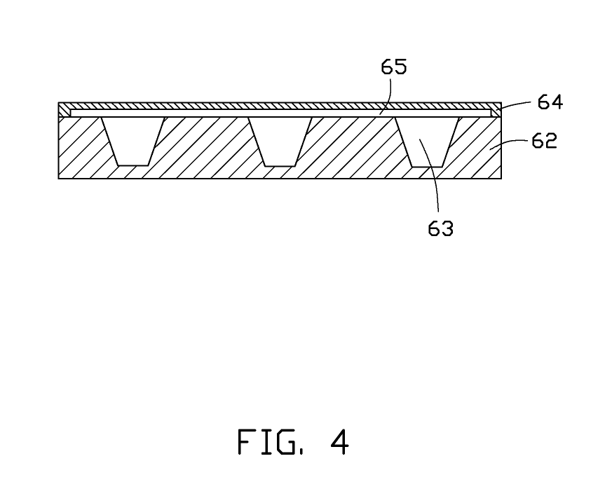

The electronic device can be a music player. The well 128 can be other shapes. Alternatively, a plurality of wells can be defined in the base 12 of the mercury connector 10. FIGS. 3 and 4, for example, show nine wells 63 defined in a base 62 and arranged in a 3×3 matrix, wherein a first well 632 at the center of the base 62 contains mercury 66. A plurality of power leads 622 and a plurality of ground leads 624 are arranged alternately along and perpendicular to corresponding edges of the base 62. First terminals of the plurality of power leads 622 are connected to the power signal terminal of the microprocessor 20. Second terminals opposite to the first terminals of the plurality of power leads 122 are at the edges of base 62. First terminals of the plurality of ground leads 124 are connected to ground signal terminals of the microprocessor 20. Second terminals opposite to the first terminals of the plurality of ground leads 124 are at the edges of the base 62. A receiving space 65 is formed between the base 62 and the cover 64. When the notebook computer 100 is moved only slightly, the mercury 66 in the first well 632 moves only into a second well 634 near the edges of the base 62 and at a lower position via the receiving space 65. The mercury 66 fails to connect the power lead 622 to the ground lead 624, and the alarm unit 30 remains inactive.

If the notebook computer 100 undergoes considerable movement, such as when picked up or moved, the mercury 66 is moved from the first well 632 to the second well 634, and continues moving out of the second well 634 to connect the second terminals of the plurality of power leads 122 to the plurality of ground leads 124, with completion of a circuit path thereby initiating microprocessor 20 to execute the alarm unit 30.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An electronic device with anti-theft protection, the electronic device comprising:
an alarm unit;
a mercury connector comprising a body containing mercury, and first and second leads arranged on the body; and
a microprocessor connected between the alarm unit and the mercury connector, the microprocessor comprising a first signal terminal connected to the first lead, and a second signal terminal connected to the second lead;
wherein when the microprocessor enters an anti-theft mode, movement of the electronic device connects the first lead to the second lead via the mercury, completing a circuit path from the first signal terminal to the second signal terminal, in response to which the microprocessor starts the alarm unit which generates an alarm.

2. The electronic device of claim 1, further comprising an electrical switch connected between a power source and the microprocessor, wherein the microprocessor enters the anti-theft mode in response to the electrical switch turning on.

3. The electronic device of claim 1, wherein the microprocessor enters the anti-theft mode by way of an application installed on the device which enables the microprocessor to enter anti-theft mode when it is detected that the electronic device has entered a standby or locked state.

4. The electronic device of claim 1, wherein the alarm unit comprises a light and/or an audio device.

5. The electronic device of claim 1, wherein a well defined in the body of the mercury connector contains mercury.

6. The electronic device of claim 5, wherein the well is tapered.

7. The electronic device of claim 5, wherein the first signal terminal of the microprocessor is a power signal terminal, the second signal terminal of the microprocessor is a ground signal terminal, a first terminal of the first lead is connected to the power signal terminal, a second terminal opposite to the first terminal of the first lead locates at an edge of a top of the well, a first terminal of the second lead is connected to the ground signal terminal, and a second terminal opposite to the first terminal of the second lead locates at the edge of the top of the well.

8. The electronic device of claim 5, wherein the body comprises a base and a cover hermetically covering the base, in which the well is defined.

9. A mercury connector connecting first and second signal terminals of an electrical element of an electronic device, the mercury connector comprising:
a body containing mercury,
a first lead arranged on the body and connected to the first signal terminal; and
a second lead arranged on the body and connected to the second signal terminal;
wherein when the electronic device is moved, the first lead is connected to the second lead via the mercury to form a circuit path from the first signal terminal to the second signal terminal.

10. The mercury connector of claim 9, wherein a well is defined in the body to contain the mercury.

11. The mercury connector of claim 10, wherein the well is tapered.

12. The mercury connector of claim 10, wherein a first terminal of the first lead is connected to the first signal terminal, a second terminal opposite to the first terminal of the first lead locates at an edge of a top of the well, a first terminal of the second lead is connected to the second signal terminal, a second terminal opposite to the first terminal of the second lead locates at the edge of the top of the well.

13. The mercury connector of claim 10, wherein the body comprises a base and a cover hermetically covering the base and the well is defined in the base.

14. The mercury connector of claim 9, wherein the body comprises a base and a cover hermetically covering the base, nine wells are defined in the base and arranged in a 3×3 matrix, wherein a first well at a center of the base contains the mercury, the first and second leads are arranged alternately along and perpendicular to corresponding edges of the base, a receiving space is formed between the base and the cover, tops of the wells communicate with the receiving space.
